(19) United States
(12) Patent Application Publication
(10) Pub. No.: US 2026/0140431 A1
(43) Pub. Date: May 21, 2026

(54) BONDING BODY AND OPTICAL COMPONENT

(71) Applicant: SEIKO EPSON CORPORATION, Tokyo (JP)

(72) Inventors: Kotaro SHIJO, CHINO-SHI (JP); Koya SHIRATORI, MATSUMOTO-SHI (JP); Kunihiko YANO, SHIOJIRI-SHI (JP)

(73) Assignee: SEIKO EPSON CORPORATION, Tokyo (JP)

(21) Appl. No.: 19/392,176

(22) Filed: Nov. 18, 2025

(30) Foreign Application Priority Data
Nov. 20, 2024 (JP) 2024-202163

(51) Int. Cl. G03B 21/20

(52) U.S. Cl. CPC G03B 21/204

(57) ABSTRACT

An optical component includes: a first member and a second member disposed to face each other, at least one of the first and second members being a light transmissive member; a first uneven portion being a light transmissive portion and configured with multiple first protrusions extending, from a first surface of the first member that is a surface facing the second member, toward the second member; and an adhesive being a light transmissive adhesive, provided to enter gaps in the first uneven portion, and configured to bond the first member and the second member to each other. In the first uneven portion, an area of a cross-section of each of the first protrusions taken along a plane perpendicular to an extending direction in which the first protrusion extends increases as the first protrusion extends from the first surface toward the second member.

The present application is based on, and claims priority from JP Application Serial Number 2024-202163, filed November 20, 2024, the disclosure of which is hereby incorporated by reference herein in its entirety.

### BACKGROUND

### 1. Technical Field

The present disclosure relates to a bonding body and an optical component.

### 2. Related Art

To bond two substrates to each other via an adhesive, there is a technology of related art for forming fine unevenness at a bonding receiving surface of each of the substrates to improve the bonding strength produced by the adhesive (refer, for example, to JP-A-2023-178289).

JP-A-2023-178289 is an example of the related art.

In the bonding body described in JP-A-2023-178289, however, it is difficult to sufficiently improve the bonding strength at the bonding receiving surfaces, and it is therefore desired to provide a novel technology capable of more firmly bonding two substrates to each other.

### SUMMARY

An optical component according to an aspect of the present disclosure includes: a first member and a second member disposed to face each other, at least one of the first and second members being a light transmissive member; a first uneven portion being a light transmissive portion and configured with multiple first protrusions extending, from a first surface of the first member that is a surface facing the second member, toward the second member; and an adhesive being a light transmissive adhesive, provided to enter gaps in the first uneven portion, and configured to bond the first member and the second member to each other. In the first uneven portion, an area of a cross-section of each of the first protrusions taken along a plane perpendicular to an extending direction in which the first protrusion extends increases as the first protrusion extends from the first surface toward the second member.

A bonding body according to another aspect of the present disclosure includes: a first member and a second member disposed to face each other; a first uneven portion configured with multiple first protrusions extending, from a first surface of the first member that is a surface facing the second member, toward the second member; and an adhesive provided to enter gaps in the first uneven portion, and configured to bond the first member and the second member to each other. In the first uneven portion, an area of a cross-section of each of the first protrusions taken along a plane perpendicular to an extending direction in which the first protrusion extends increases as the first protrusion extends from the first surface toward the second member.

### BRIEF DESCRIPTION OF THE DRAWINGS

FIG. 1 is a schematic configuration diagram showing a projector in a first embodiment.

FIG. 2 is a schematic configuration diagram showing an illuminator.

FIG. 3 is a cross-sectional view showing an optical component in the first embodiment.

FIG. 4 is a step flowchart showing an embodiment of a film formation method.

FIG. 5 is a cross-sectional view showing a variation of the optical component in the first embodiment.

FIG. 6 is a cross-sectional view showing a schematic configuration of a wavelength converter in a second embodiment.

FIG. 7 is a cross-sectional view showing a bonding body according to a third embodiment.

### DESCRIPTION OF EMBODIMENTS

### First embodiment

A first embodiment of the present disclosure will be described below with reference to the drawings.

In the drawings below, some elements may be shown at different dimensional scales to clarify the elements.

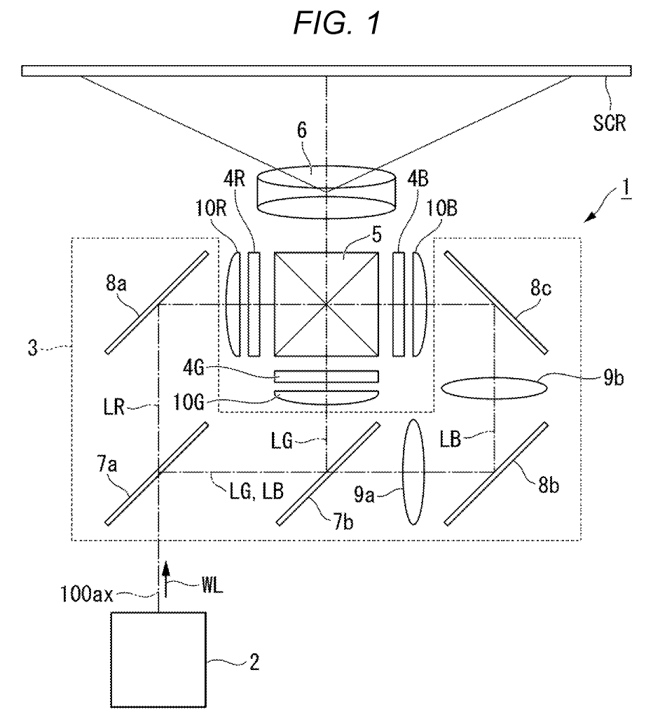

FIG. 1 is a schematic configuration diagram showing a projector according to the first embodiment.

A projector 1 according to the present embodiment is a projection-type image display apparatus that displays video images on a screen SCR, as shown in FIG. 1. The projector 1 includes an illuminator 2, a color separation system 3, light modulators 4R, 4G, and 4B, a light combining system 5, and a projection optical apparatus 6.

The illuminator 2 outputs white illumination light WL toward the color separation system 3. The configuration of the illuminator 2 will be described later in detail.

The color separation system 3 separates the illumination light WL output from the illuminator 2 into red light LR, green light LG, and blue light LB. The color separation system 3 includes a first dichroic mirror 7a, a second dichroic mirror 7b, a first reflection mirror 8a, a second reflection mirror 8b, a third reflection mirror 8c, a first relay lens 9a, and a second relay lens 9b.

The first dichroic mirror 7a separates the illumination light WL from the illuminator 2 into the red light LR and light containing the green light LG and the blue light LB. The first dichroic mirror 7a transmits the red light LR and reflects the light containing the green light LG and the blue light LB. The second dichroic mirror 7b reflects the green light LG and transmits the blue light LB. The second dichroic mirror 7b thus separates the light containing the green light LG and the blue light LB into the green light LG and the blue light LB.

The first reflection mirror 8a is disposed in the optical path of the red light LR and reflects the red light LR having passed through the first dichroic mirror 7a toward the light modulator 4R. The second reflection mirror 8b and the third reflection mirror 8c are disposed in the optical path of the blue light LB, and guide the blue light LB having passed through the second dichroic mirror 7b to the light modulator 4B. The green light LG is reflected off the second dichroic mirror 7b toward the light modulator 4G.

The first relay lens 9a is disposed between the second dichroic mirror 7b and the second reflection mirror 8b in the optical path of the blue light LB. The second relay lens 9b is disposed between the second reflection mirror 8b and the third reflection mirror 8c in the optical path of the blue light LB. The first relay lens 9a and the second relay lens 9b compensate for optical loss of the blue light LB resulting from the fact that the optical path length of the blue light LB is longer than the optical path lengths of the red light LR and the green light LG.

The light modulator 4R modulates the red light LR in accordance with image information to form image light corresponding to the red light LR. The light modulator 4G modulates the green light LG in accordance with the image information to form image light corresponding to the green light LG. The light modulator 4B modulates the blue light LB in accordance with the image information to form image light corresponding to the blue light LB.

The light modulators 4R, 4G, and 4B are each, for example, a transmissive liquid crystal panel. Polarizers that are not shown are disposed at the light incident and exiting sides of each of the liquid crystal panels.

A field lens 10R is disposed on the light incident side of the light modulator 4R. The field lens 10R parallelizes the red light LR to be incident on the light modulator 4R. A field lens 10G is disposed on the light incident side of the light modulator 4G. The field lens 10G parallelizes the green light LG to be incident on the light modulator 4G. A field lens 10B is disposed on the light incident side of the light modulator 4B. The field lens 10B parallelizes the blue light LB to be incident on the light modulator 4B.

The image light output from the light modulator 4R, the image light output from the light modulator 4G, and the image light output from the light modulator 4B enter the light combining system 5. The light combining system 5 combines the image light corresponding to the red light LR, the image light corresponding to the green light LG, and the image light corresponding to the blue light LB with one another and outputs the combined image light toward the projection optical apparatus 6. The light combining system 5 is, for example, a cross dichroic prism.

The projection optical apparatus 6 includes multiple projection lenses. The projection optical apparatus 6 enlarges the combined image light from the light combining system 5 and projects the enlarged image light toward the screen SCR. Enlarged video images are thus displayed on the screen SCR.

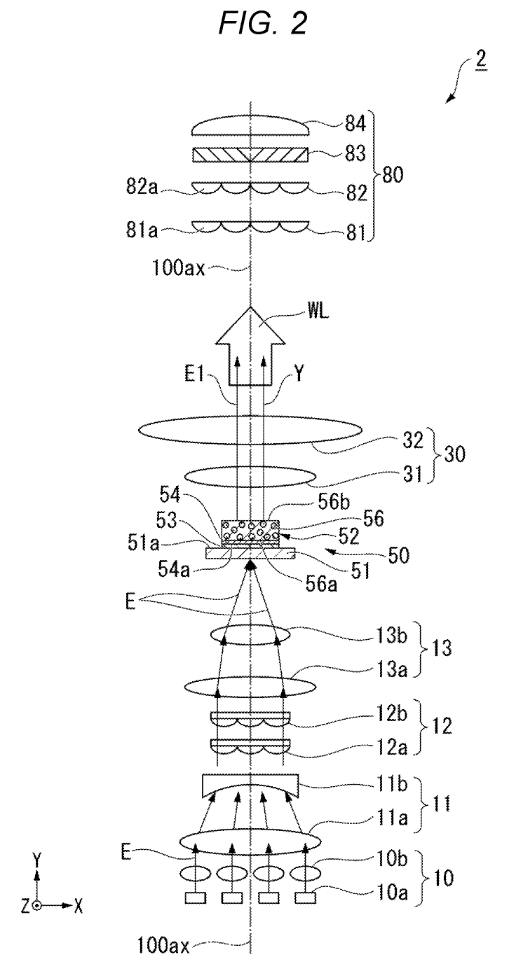

FIG. 2 is a schematic configuration diagram showing the illuminator 2 according to a second embodiment.

In FIG. 2, elements common to those in the figure used in the embodiment described above have the same reference characters, and will not be described.

The illuminator 2 includes an excitation light source unit 10, an afocal optical system 11, a homogenizer optical system 12, a light collecting optical system 13, a wavelength converter 50, a pickup optical system 30, and a uniform illumination optical system 80, as shown in FIG. 2.

The excitation light source unit 10 is configured with multiple semiconductor lasers 10a, which each output blue excitation light E, which is laser light, and multiple collimator lenses 10b. The multiple semiconductor lasers 10a are arranged in an array in a plane perpendicular to an illumination optical axis 100ax. The collimator lenses 10b are arranged in an array in a plane perpendicular to the illumination optical axis 100ax in correspondence with the respective semiconductor lasers 10a. The collimator lenses 10b each convert the excitation light E output from the semiconductor laser 10a corresponding to the collimator lens 10b into parallel light.

The afocal optical system 11 includes, for example, a convex lens 11a and a concave lens 11b. The afocal optical system 11 reduces the luminous flux diameter of the excitation light E formed of the parallel luminous fluxes output from the excitation light source unit 10.

The homogenizer optical system 12 includes, for example, a first multi-lens array 12a and a second multi-lens array 12b. The homogenizer optical system 12 makes the optical intensity distribution of the excitation light uniform on a phosphor element 52 of the wavelength converter 50, that is, what is called a top hat distribution.

The homogenizer optical system 12, together with the light collecting optical system 13, superimposes multiple narrow luminous fluxes output from the multiple lenses of the first multi-lens array 12a and the second multi-lens array 12b on one another on the phosphor element 52 of the wavelength converter 50. The optical intensity distribution of the excitation light E radiated onto the phosphor element 52 is thus made uniform.

The light collecting optical system 13 includes, for example, a first lens 13a and a second lens 13b. In the present embodiment, the first lens 13a and the second lens 13b are each configured with a convex lens. The light collecting optical system 13 is disposed in the optical path from the homogenizer optical system 12 to the wavelength converter 50, collects the excitation light E, and causes the collected excitation light E to enter the phosphor element 52 of the wavelength converter 50.

The pickup optical system 30 includes, for example, a first collimating lens 31 and a second collimating lens 32. The pickup optical system 30 is a parallelizing optical system that substantially parallelizes the light output from the phosphor element 52 of the wavelength converter 50. The first collimating lens 31 and the second collimating lens 32 are each configured with a convex lens. The light parallelized by the pickup optical system 30 enters the uniform illumination optical system 80.

The uniform illumination optical system 80 includes a first lens array 81, a second lens array 82, a polarization converter 83, and a superimposing lens 84.

The first lens array 81 includes multiple first lenses 81a, which divide the illumination light WL from the illuminator 2 into multiple sub-luminous fluxes. The multiple first lenses 81a are arranged in a matrix in a plane perpendicular to the illumination optical axis 100ax.

The second lens array 82 includes multiple second lenses 82a corresponding to the multiple first lenses 81a of the first lens array 81. The multiple second lenses 82a are arranged in a matrix in a plane perpendicular to the illumination optical axis 100ax.

The second lens array 82, together with the superimposing lens 84, forms images of the first lenses 81a of the first lens array 81 in the vicinity of image formation regions of the light modulator 4R, the light modulator 4G, and the light modulator 4B.

The polarization converter 83 converts the light output from the second lens array 82 into one kind of linearly polarized light. The polarization converter 83 includes, for example, polarization separation films and retardation films (none of which is shown).

The superimposing lens 84 collects the sub-luminous fluxes output from the polarization converter 83 and superimposes the collected luminous fluxes on one another in the vicinity of the image formation regions of the light modulator 4R, the light modulator 4G, and the light modulator 4B.

The wavelength converter 50 in the present embodiment corresponds to an example of an optical component according to the present disclosure. The wavelength converter (optical component) 50 includes a support substrate (first member) 51, the phosphor element (second member) 52, and a bonding layer 53. The wavelength converter 50 is a fixed wavelength converter in which the position where the excitation light E is incident on the phosphor element 52 does not change over time.

The phosphor element 52 in the present embodiment causes the excitation light E to be incident on a rear surface 56a facing the support substrate 51, and emits fluorescence Y via a front surface 56b. That is, the phosphor element 52 is a light transmissive element. In the wavelength converter 50 in the present embodiment, the phosphor element 52 transmits and outputs not only the fluorescence Y but also part of excitation light E1 not having undergone the wavelength conversion. The white illumination light WL is thus output from the phosphor element 52.

The phosphor element 52 includes a phosphor layer 56 and an optical layer 54. The phosphor element 56 contains a ceramic phosphor formed of a polycrystalline phosphor that converts the excitation light E in terms of wavelength into the fluorescence Y. A second wavelength band to which the fluorescence Y belongs is a yellow wavelength band ranging, for example, from 490 to 750 nm. That is, the fluorescence Y is yellow fluorescence containing a red light component and a green light component.

The phosphor layer 56 may contain a monocrystalline phosphor in place of a polycrystalline phosphor. The phosphor layer 56 may instead be made of fluorescent glass. Still instead, the phosphor layer 56 may be configured with a binder which is made of glass or resin and in which a large number of phosphor particles are dispersed. The phosphor element 52 made of such a material converts the excitation light E into the fluorescence Y having the second wavelength band.

Specifically, the material of the phosphor layer 56 contains, for example, an yttrium-aluminum-garnet-based (YAG-based) phosphor. Consider YAG:Ce, which contains cerium (Ce) as an activator, by way of example, and the phosphor layer 56 is made, for example, of a material produced by mixing raw powder materials containing Y₂O₃, Al₂O₃, CeO₃, and other constituent elements with one another and causing the mixture to undergo a solid-phase reaction, Y-Al-O amorphous particles produced by using a coprecipitation method, a sol-gel method, or any other wet method, or YAG particles produced by using a spray-drying method, a flame-based thermal decomposition method, a thermal plasma method, or any other gas-phase method.

The optical layer 54 is provided at the rear surface 56a of the phosphor element 56, which is the light-incident-side surface. The optical layer 54 is configured with a dichroic mirror that transmits the excitation light E and reflects the fluorescence Y. That is, the optical layer 54 is a light transmissive layer.

In the following description, an X-Y-Z orthogonal coordinate system is used as required in the drawings. The X-axis is an axis parallel to the direction in which the support substrate 51 extends in FIG. 2. The Y-axis is an axis orthogonal to the X-axis and parallel to the thickness direction of the support substrate 51. The Z-axis is an axis orthogonal to the X-axis and the Y-axis. The Y-axis direction in the present embodiment corresponds to an "extending direction" in the claims.

The support substrate 51 supports the phosphor element 52 via the bonding layer 53. The support substrate 51 and the phosphor element 52 are disposed to face each other via the bonding layer 53. The support substrate 51 is made, for example, of a light transmissive material such as glass or plastic. The bonding layer 53 is a light transmissive layer. The bonding layer 53 bonds a front surface 51a of the support substrate 51 to an optical surface 54a of the optical layer 54, which is provided at the rear surface 56a of the phosphor layer 56. The configuration of the bonding layer 53 will be described later in detail.

In the present embodiment, the support substrate 51 corresponds to the "first member" in the claims, and the phosphor element 52 corresponds to the "second member" in the claims. The front surface 51a corresponds to the "first surface" in the claims, and the optical surface 54a corresponds to the "second surface" in the claims.

The wavelength converter 50 in the present embodiment, in which the support substrate 51 and the phosphor element 52 are each a light-transmissive element, functions as a transmissive wavelength converter that outputs the illumination light WL containing the fluorescence Y via the surface 56b opposite the rear surface 56a of the phosphor layer 56, on which the excitation light E is incident.

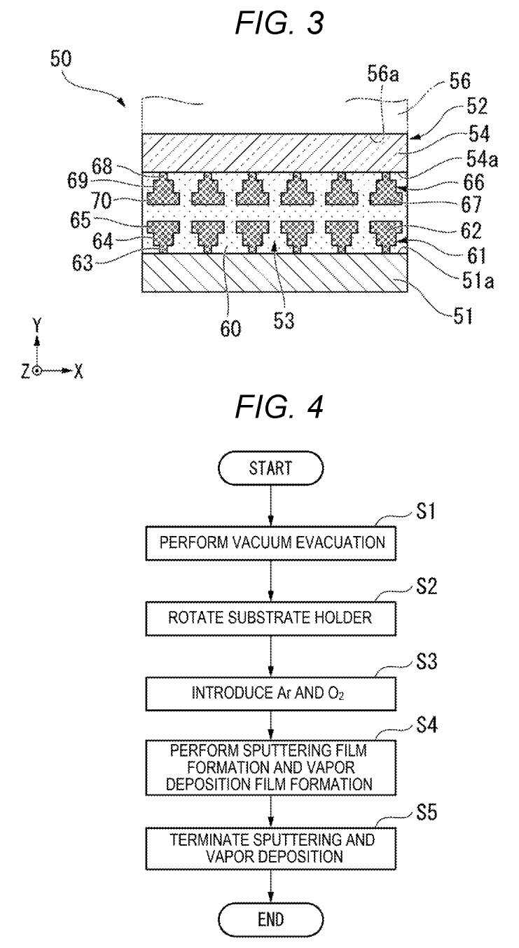

FIG. 3 corresponds to a cross-sectional view of the wavelength converter 50 taken along an XY plane containing the illumination optical axis 100ax in FIG. 2. The bonding layer 53 includes an uneven portion (first uneven portion) 61, an uneven portion (second uneven portion) 66, and an adhesive 60, as shown in FIG. 3.

The uneven portion 61 is configured with multiple protrusions (first protrusions) 62. The protrusions 62 each extend from the front surface 51a of the support substrate 51 toward the phosphor element 52. The size of each of the protrusions 62 is smaller than the wavelength of the excitation light E passing through the bonding layer 53.

The protrusions 62 are each a light transmissive protrusion. The protrusions 62 are made, for example, of an inorganic material such as SiO₂. The protrusions 62 therefore have high heat resistance as compared with a case where the protrusions 62 are made of a resin material.

The protrusions 62 each include a base end portion 63, a central portion 64, and a front end portion 65. The protrusions 62 are each as a whole so tapered that the outer diameter thereof increases in the direction in which the protrusion 62 extends. The area of the cross-section of each of the protrusions 62 taken along the XZ plane along the X-axis and the Z-axis directions increases stepwise as the protrusion 62 extends from the front surface 51a toward the phosphor element 52. In the present embodiment, each of the protrusions 62 has a cross-sectional area that changes in two steps, and is configured with portions having three different cross-sectional areas. In the present embodiment, the XZ plane corresponds to the "plane perpendicular to a direction in which the first protrusion extends" in the claims. It is hereinafter assumed that the cross-sectional area refers to the cross-sectional area in the XZ plane.

The base end portion 63 is formed at the front surface 51a of the support substrate 51. The side surface of the base end portion 63 extends along the Y-axis direction from the front surface 51a toward the phosphor element 52.

The central portion 64 extends along the Y-axis direction from the end of the base end portion 63 toward the phosphor element 52. The cross-sectional area of the central portion 64 is greater than the cross-sectional area of the base end portion 63.

The front end portion 65 extends along the Y-axis direction from the end of the central portion 64 toward the phosphor element 52. The cross-sectional area of the front end portion 65 is greater than the cross-sectional area of the central portion 64.

In the uneven portion 61, the area of the cross-section of each of the protrusions 62 taken along a plane perpendicular to the direction in which the protrusion 62 extends increases as the protrusion 62 extends from the front surface 51a.

The uneven portion 66 is configured with multiple protrusions (second protrusions) 67. The protrusions 67 each extend from the optical surface 54a of the optical layer 54 toward the support substrate 51. The size of each of the protrusions 67 is smaller than the wavelength of the excitation light E passing through the bonding layer 53.

The protrusions 67 are each a light transmissive protrusion. The protrusions 67 are made, for example, of an inorganic material such as SiO₂. The protrusions 67 therefore have high heat resistance as compared with a case where the protrusions 67 are made of a resin material.

The protrusions 67 each include a base end portion 68, a central portion 69, and a front end portion 70. The protrusions 67 are each as a whole so tapered that the outer diameter thereof changes, that is, increases in the direction in which the protrusion 67 extends. The area of the cross-section of each of the protrusions 67 taken along the XZ plane increases stepwise as the protrusion 67 extends from the optical surface 54a toward the support substrate 51. In the present embodiment, each of the protrusions 67 has a cross-sectional area that changes in two steps, and is configured with portions having three different cross-sectional areas. In the present embodiment, the XZ plane also corresponds to the "plane perpendicular to a direction in which the second protrusion extends" in the claims.

The base end portion 68 is formed at the optical surface 54a of the optical layer 54. A side surface portion of the base end portion 68 extends along the Y-axis direction from the optical surface 54a toward the support substrate 51.

The central portion 69 extends along the Y-axis direction from the end of the base end portion 68 toward the support substrate 51. The cross-sectional area of the central portion 69 is greater than the cross-sectional area of the base end portion 68.

The front end portion 70 extends along the Y-axis direction from the end of the central portion 69 toward the support substrate 51. The cross-sectional area of the front end portion 70 is greater than the cross-sectional area of the central portion 69.

In the uneven portion 66, the area of the cross-section of each of the protrusions 67 taken along a plane perpendicular to the direction in which the protrusion 67 extends increases as the protrusion 67 extends from the optical surface 54a.

The adhesive 60 is provided in a portion of the bonding layer 53 that is the portion excluding the uneven portion 61 and the uneven portion 66. The adhesive 60 is provided to enter the gap between the uneven portion 61 and the uneven portion 66. The adhesive 60 is a light-transmissive optical adhesive made, for example, of epoxy resin. The adhesive 60 hardens in the gap between the uneven portion 61 and the uneven portion 66, and bonds the support substrate 51 and the optical layer 54 to each other.

The cross-sectional area of each of the protrusions 62 and 67 increases as the protrusion extends from the front surface 51a or the optical surface 54a. Therefore, when a tensile force acts on the adhesive 60 having penetrated into the gap between the uneven portion 61 and the uneven portion 66, an anchor effect is exhibited. In this process, the front end portion 65 or 70 and the central portion 64 or 69 of each of the protrusions 62 and 67 bite into the adhesive 60, so that the bonding between the protrusions 62, 67 and the adhesive 60 can be strengthened. The bonding strength between the support substrate 51 and the optical layer 54 can therefore be increased.

Furthermore, the cross-sectional area of each of the protrusions 62 and 67 changes stepwise. The surface area of each of the protrusions 62 and 67 thus increases. The contact area between each of the protrusions 62, 67 and the adhesive 60 therefore increases. The bonding strength between the support substrate 51 and the optical layer 54 can therefore be further increased.

A method for manufacturing the bonding layer 53 in the wavelength converter 50 in the present embodiment will be subsequently described. Specifically, a method for changing the cross-sectional area of each of the protrusions 62 and 67 will be described. In the present embodiment, the film formation method disclosed in JP-A-2018-123365 is used. The film formation method includes the following two steps alternately repeatedly carried out: the step of forming a film of a vapor deposition material at a surface of a substrate through vacuum vapor deposition; and the step of forming a film of a target constituent substance through sputtering. The film formation method described above allows formation of the uneven portions 61 and 66.

A film formation apparatus used in the film formation method described above is provided with a sputtering mechanism and a vacuum vapor deposition mechanism in a single vacuum container. The film formation apparatus includes a rotary substrate holder that rotatably holds a film formation target object. The film formation target object can thus be moved between a sputtering region formed by the sputtering mechanism and a vapor deposition region formed by the vacuum vapor deposition mechanism.

When the sputtering film formation and the vacuum vapor deposition film formation are alternately repeated, the ratio between the weight of the film produced by the sputtering and the weight of the film produced by the vacuum vapor deposition and the total amount of the formed film (film thickness) can be set to desired values by adjusting the period for which the substrate stays in a differential pressure region in the sputtering film formation and a high vacuum region in the vacuum vapor deposition film formation, the film formation conditions for the sputtering mechanism or the vacuum vapor deposition mechanism, and other factors.

A method for forming the uneven portion 61 at the front surface 51a of the support substrate 51 will be described below. The film formation method in the present embodiment includes the following two steps alternately repeatedly carried out: the step of forming a SiO₂ film at the front surface 51a of the support substrate 51 through sputtering using the sputtering mechanism; and the step of forming a SiO₂ film through vacuum vapor deposition using the vacuum vapor deposition mechanism. Note in the present film formation method that the sputtering film formation and the vapor deposition film formation do not need to be alternately repeated each once, but one of the sputtering film formation and the vapor deposition film formation may be repeated multiple times, and then the other may be carried out the same multiple times.

As a preliminary preparation, the support substrate 51 is placed in the substrate holder, which is then loaded into the vacuum container. An Si target is placed as a target, a crucible is filled with SiO₂ as a vapor deposition material, and then the process shown in FIG. 4 is initiated. FIG. 4 is a step flowchart showing an embodiment of the film formation method according to the present disclosure.

In step S1, the vacuum container is sealed, and the interior of the vacuum container is evacuated (depressurized) by using an exhauster, as shown in FIG. 4. Note that the evacuation is repeated until the interior of the vacuum chamber reaches a predetermined pressure.

When the interior of the vacuum container reaches the predetermined pressure, it is considered that the pressure is reduced to a degree of vacuum suitable for vacuum deposition performed by the vacuum vapor deposition mechanism, and the process proceeds to step S2 to start rotation of the substrate holder.

In step S3, valves of gas cylinders containing, for example, an oxygen gas and an argon gas are opened to introduce the gases from the gas cylinders to the differential pressure region in a differential pressure container. When the oxygen gas and the argon gas are introduced to the differential pressure region, the oxygen gas and the argon gas are locally introduced into the differential pressure region having been depressurized by the exhauster, and a very small amount of the gases leaks out of the differential pressure container through a gap at a fixed flow rate.

When the amounts of the gases introduced to the differential pressure region and the amounts of the gases leaking from the differential pressure region via the gap balance each other in a predetermined manner, the pressure in the differential pressure region becomes a pressure suitable for the sputtering film formation.

Subsequently, in step S4, a shutter having covered the target is opened to perform the sputtering film formation, and a shutter having closed the crucible is opened to irradiate the crucible with an electron beam from an electron gun to perform the vacuum vapor deposition film formation. Note that the vacuum vapor deposition film formation is repeated until the film thickness of each of the protrusions 62 of the uneven portion 61 formed on the front surface 51a of the support substrate 51 reaches a predetermined required film thickness.

When the film thickness of the thin film formed on the substrate reaches the predetermined required film thickness, the process proceeds to step S5. In step S5, the sputtering film formation is terminated by covering the target with the shutter and closing the valves of the gas cylinders, and the vacuum vapor deposition film formation is terminated by turning off the electron gun and closing the shutter. Thereafter, the internal pressure in the vacuum container is brought back to the atmospheric pressure, and the support substrate 51 held by the substrate holder is taken out from the vacuum container.

The uneven portion 61 is formed at the front surface 51a of the support substrate 51 by repeating the step of forming the vapor deposition material through the vacuum deposition, and the step of forming the target constituent substance through sputtering as described above.

In the present film formation method, for example, it is known that lowering the pressure in the differential pressure region lowers the density of the formed film. That is, when the pressure in the differential pressure region is lowered, the cross-sectional area of each of the protrusions 62 can be reduced. Similarly, when the pressure in the differential pressure region is raised, the cross-sectional area of each of the protrusions 62 can be increased.

Therefore, adjusting the pressure in the differential pressure region can change the cross-sectional area of each of the protrusions 62 formed at the front surface 51a of the support substrate 51 to any size.

The uneven portion 61 including the protrusions 62 formed by the present film formation method has a fine uneven structure and has a refractive index smaller than that of SiO₂, which is the film forming material. Light reflection and scattering at the uneven portion 61 formed at the front surface 51a of the support substrate 51 are therefore suppressed, so that light loss that occurs when the light is incident on the uneven portion 61 via the front surface 51a of the support substrate 51 can be reduced.

The uneven portion 66 can be formed by using the film formation method described above, as the uneven portion 61. Therefore, adjusting the pressure in the differential pressure region can change the cross-sectional area of each of the protrusions 67 formed at the optical surface 54a of the optical layer 54 to any size.

The uneven portion 66 including the protrusions 67 formed by the present film formation method has a fine uneven structure and has a refractive index smaller than that of SiO₂, which is a film forming material, as the uneven portion 61. Light reflection and scattering at the uneven portion 66 formed at the optical surface 54a of the optical layer 54 are therefore suppressed, so that light loss that occurs when the light passes through the uneven portion 66 and enters the optical layer 54 can be reduced.

The above description has been made with reference to the case where SiO₂ is used as the target constituent substance as an example, and the vapor deposition material, and the target constituent substance may instead, for example, be a metal target such as Si, Zr, Al, Ti, Ta, Nb, or Hf, or a metal oxide of any of the metals. The vapor deposition material may, for example, be MgF₂, Al₂O₃, ZrO₂, Ta₂O₅, TiO₂, Nb₂O₅, or HfO₂. In this case, an oxide of the same metal or an oxide thereof that constitutes the target may be used, or an oxide of a metal different from the metal or an oxide thereof that constitutes the target may be used.

As described above, the wavelength converter 50 in the present embodiment includes the support substrate 51 and the phosphor element 52 disposed to face each other, at least one of the support substrate 51 and the phosphor element 52 being a light transmissive element; the uneven portion 61 being a light transmissive portion and configured with the multiple protrusions 62 extending from the front surface 51a of the support substrate 51, which is the surface facing the phosphor element 52, toward the phosphor element 52; and the adhesive 60 being a light transmissive adhesive, provided to enter the gaps in the uneven portion 61, and bonding the support substrate 51 and the phosphor element 52 to each other, and in the uneven portion 61, the area of the cross-section of each of the protrusions 62 taken along a plane perpendicular to the direction in which the protrusions 62 extends increases as the protrusion 62 extends from the front surface 51a toward the phosphor element 52.

In the wavelength converter 50 in the present embodiment, the cross-sectional area of each of the protrusions 62 increases as the distance from the front surface 51a and the optical surface 54a increases. As a result, an anchor effect is exhibited when a tensile force acts on the adhesive 60 having penetrated into the gaps in the uneven portion 61. In this process, the front end portion 65 and the central portion 64 of each of the protrusions 62 bite into the adhesive 60, so that the bonding between the protrusions 62 and the adhesive 60 can be strengthened. The bonding strength between the support substrate 51 and the optical layer 54 can therefore be increased.

Since the size of each of the protrusions 62 and 67 is smaller than the wavelength of the excitation light E, which passes through the bonding layer 53, scattering of the light in the bonding layer 53 can be suppressed, as described above. The bonding strength can therefore be increased with the scattering of the light suppressed, which is suitable for applications such as optical components that require light transparency.

Furthermore, in the wavelength converter 50 in the present embodiment, as an example of the adhesive 60, it is conceivable to use in some cases a material that reacts with surrounding moisture to harden at the time of hardening, such as polysilazane. In this process, since sealed portions, such as the gap between the base end portions 63 and the front surface 51a and the gap between the base end portions 68 and the optical surface 54a, are not in contact with air, it is difficult to absorb moisture. Therefore, the reaction is unlikely to proceed, and the adhesive is unlikely to harden. As a countermeasure, it is conceivable to employ a method for performing the bonding after humidity is added in a high-humidity environment during manufacturing of the wavelength converter 50. In this process, since the gap between the base end portions 63 and the front surface 51a and the gap between the base end portions 68 and the optical surface 54a are narrow, the moisture is unlikely to leak to the outer atmosphere. The bonding can therefore be performed while maintaining the moisture necessary for hardening the adhesive made of polysilazane.

In the present embodiment, the protrusions 62 and 67 are made of an inorganic material. The bonding layer 53 in the present embodiment can therefore also be used in bonding using a glass-based material that requires high-temperature sintering, such as polysilazane.

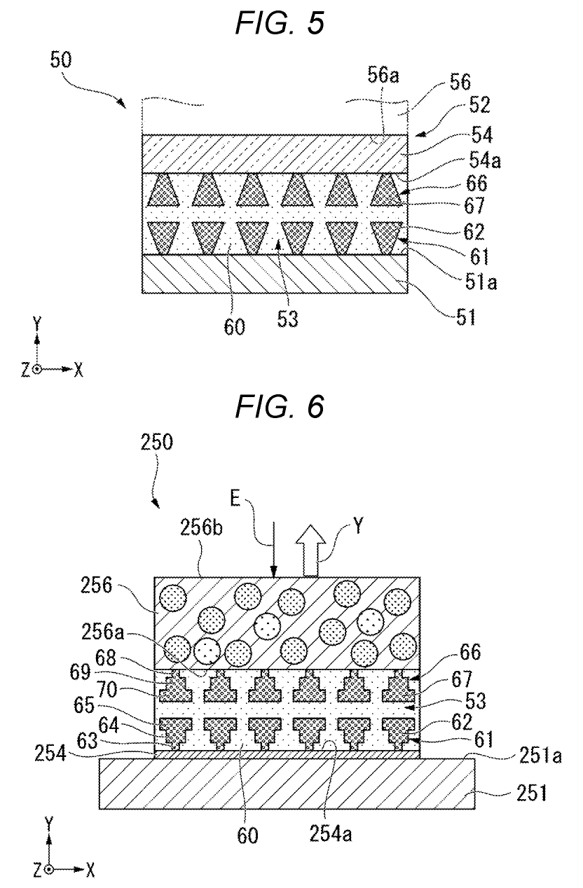

FIG. 5 shows a variation in the present embodiment. FIG. 5 corresponds to a cross-sectional view of the wavelength converter 50 taken along a plane containing the illumination optical axis 100ax in FIG. 2. The first embodiment has been described with reference to the case where the cross-sectional area of each of the protrusions 62 and 67 changes stepwise. The protrusions 62 may instead each continuously change in a direction away from the front surface 51a, as shown in FIG. 5. Similarly, the protrusions 67 may each continuously change in a direction away from the optical surface 54a.

In this case, the pressure in the differential pressure region during the film formation described above can be readily controlled, as compared with the aforementioned case, where the cross-sectional area of each of the protrusions 62 and 67 changes stepwise. Management at the time of manufacturing the wavelength converter 50 is therefore facilitated.

In the wavelength converter 50 according to the embodiment described above, both the protrusions 62 and 67 are formed, but only the protrusions 62 may be formed at the front surface 51a of the support substrate 51.

Instead, only the protrusions 67 may be formed on the side facing the phosphor element 52. In this case, the optical surface 54a of the optical layer 54 corresponds to the "first surface of the first member" in the claims.

Furthermore, the protrusions 62 and 67 may not be formed across the front surface 51a and the optical surface 54a, respectively, but may be formed only partially.

The present embodiment has been described with reference to the case where the cross-sectional area of each of the protrusions 62 and 67 changes in two steps, but not necessarily, and the cross-sectional area may be changed different times. When the cross-sectional area is changed stepwise only in one step, the central portion 64 or 69 in the present embodiment is not present, and the protrusions 62 and 67 are configured only with the base end portions 63 and 68 and the front end portions 65 and 70, respectively. When the cross-sectional area is changed stepwise in three or more steps, the number of the central portions 64 and 69 increases, and portions having different cross-sectional areas are formed.

The present embodiment has been further described with reference to the case where the wavelength converter is used in a projector, and the wavelength converter may be used in other optical component applications. As another optical component, for example, the bonding layer 53 in the first embodiment may be used to bond a lens to a cover glass plate of a light source having a package structure. In this case, one of the cover glass plate of the light source and the lens corresponds to the first member, and the other corresponds to the second member.

### Second embodiment

A second embodiment of the present disclosure will be described below with reference to FIG. 6. The basic configuration of the projector according to the present embodiment is the same as that in the first embodiment, but the configuration of the wavelength converter differs from that in the first embodiment. FIG. 6 is a cross-sectional view showing a schematic configuration of a wavelength converter 250 according to the present embodiment. In FIG. 6, elements common to those in the drawings used in the description of the first embodiment have the same reference characters, and will not be described.

The wavelength converter (optical part) 250 includes a support substrate (first member) 251, a phosphor layer (second member) 256, the bonding layer 53, and a reflection layer 254, as shown in FIG. 6. The wavelength converter 250 in the present embodiment is a fixed wavelength converter in which the position where the excitation light E is incident on the phosphor layer 256 does not change over time.

The support substrate 251 supports the bonding layer 53 and the phosphor layer 256 via the reflection layer 254. The support substrate 251 is not a light transmissive substrate, and is made of a metal material having high thermal conductivity such as aluminum or copper.

The phosphor layer 256 contains at least a phosphor and converts blue excitation light E into yellow fluorescence Y. The excitation light E enters the wavelength converter 50 via a front surface 256b of the phosphor layer 256. The phosphor layer 256 converts the incident excitation light E in terms of wavelength into the fluorescence Y, and outputs the fluorescence Y via the front surface 256b, which is the surface on which the excitation light E is incident. The phosphor layer 256 is made of the same material as the phosphor layer 56 in the first embodiment.

In the present embodiment, the support substrate 251 corresponds to the "first member" in the claims, and the phosphor layer 256 corresponds to the "second member" in the claims.

The bonding layer 53 is a light transmissive layer. The configuration of the bonding layer 53 is the same as that in the first embodiment as a whole. The bonding layer 53 includes the uneven portion 61, the uneven portion 66, and the adhesive 60.

The uneven portion 61 is configured with the multiple protrusions 62. The protrusions 62 each extend from a reflection surface (first surface) 254a of the reflection layer 254 toward the phosphor layer 256. The shape of each of the protrusions 62 is the same as that in the first embodiment.

The uneven portion 66 is configured with the multiple protrusions 67. The protrusions 67 each extend from a rear surface (second surface) 256a of the phosphor layer 256 toward the reflection layer 254. The shape of each of the protrusions 67 is the same as that in the first embodiment.

The bonding layer 53 bonds the reflection surface 254a of the reflection layer 254 to the rear surface 256a of the phosphor layer 256.

In the present embodiment, the reflection surface 254a corresponds to the "first surface" in the claims, and the rear surface 256a corresponds to the "second surface" in the claims.

The reflection layer 254 is provided to face the rear surface 256a of the phosphor layer 256 with the bonding layer 53 sandwiched therebetween. That is, the reflection layer 254 is provided between the support substrate 251 and the rear surface 256a of the phosphor layer 256. The reflection layer 254 is configured with a metal film made, for example, of silver having high optical reflectance, a dielectric multilayer film, or a combination thereof. The reflection layer 254 reflects the fluorescence Y traveling toward the side opposite the light incident side (side facing rear surface 256a) toward the light incident side (side facing front surface 256b) in the phosphor layer 256. Note that the reflection layer 254 may reflect part of the excitation light E toward the light incident side (side facing front surface 256b), and the excitation light E reflected off the reflection layer 254 is used to excite the phosphor to produce the fluorescence Y.

In the wavelength converter 250 in the second embodiment, since the phosphor layer 256 is a light-transmissive layer, the fluorescence Y reflected off the reflection layer 254 can pass through the bonding layer 53 and the phosphor layer 256 and exit via the front surface 256b of the phosphor layer 256. The wavelength converter 250 according to the present embodiment thus functions as a reflective wavelength converter that outputs the fluorescence Y via the front surface 256b of the phosphor layer 256, on which the excitation light E is incident.

As described above, the wavelength converter 250 includes the bonding layer 53 having the same shape as that in the first embodiment. The bonding strength between the reflection layer 254 and the phosphor layer 256 can therefore be increased. A reflective wavelength converter providing the same advantages as those in the first embodiment can therefore be provided.

The variation shown in FIG. 5 may be applied to the present embodiment, as in the first embodiment.

### Third embodiment

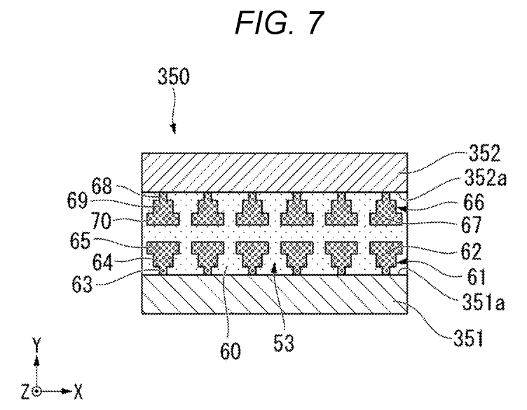

A third embodiment of the present disclosure will be described below with reference to FIG. 7. The bonding layer 53 in the present embodiment is configured in the same manner as in the first and second embodiments. The present embodiment will be described with reference to a case where the bonding layer 53 is used as a typical bonding body. FIG. 7 corresponds to FIG. 3 in the first embodiment. In FIG. 7, elements common to those in the drawings used in the description of the first embodiment have the same reference characters, and will not be described.

A bonding body 350 in the present embodiment includes a first member 351, a second member 352, and the bonding layer 53, as shown in FIG. 7. The first member 351 is bonded to the second member 352 via the bonding layer 53. The first member 351 and the second member 352 are disposed to face each other via the bonding layer 53.

The first member 351 and the second member 352 are not light transmissive members, and are made, for example, of a plastic, glass, or metal material.

The bonding layer 53 is a light transmissive layer. The bonding layer 53 is configured as a whole in the same manner as in the first and second embodiments. The bonding layer 53 includes the uneven portion 61, the uneven portion 66, and the adhesive 60.

The uneven portion 61 is configured with the multiple protrusions 62. The protrusions 62 each extend from a first surface 351a of the first member 351 toward the second member 352. The protrusions 62 are each shaped in the same manner as in the first and second embodiments.

The uneven portion 66 is configured with the multiple protrusions 67. The protrusions 67 each extend from a second surface 352a of the second member 352 toward the first member 351. The protrusions 67 are each shaped in the same manner as in the first and second embodiments.

The bonding layer 53 bonds the first surface 351a of the first member 351 to the second surface 352a of the second member 352.

As described above, the bonding body 350 includes the bonding layer 53 shaped in the same manner as in the first and second embodiments. The cross-sectional area of each of the protrusions 62 and 67 therefore increases as the protrusion extends from the first surface 351a or the second surface 352a. Therefore, when a tensile force acts on the adhesive 60 having penetrated into the gap between the uneven portion 61 and the uneven portion 66, an anchor effect is exhibited. In this process, the front end portion 65 or 70 and the central portion 64 or 69 of each of the protrusions 62 and 67 bite into the adhesive 60, so that the bonding between the protrusions 62, 67 and the adhesive 60 can be strengthened. The bonding strength between the first member 351 and the second member 352 can therefore be increased.

Furthermore, the cross-sectional area of each of the protrusions 62 and 67 changes stepwise. The surface area of each of the protrusions 62 and 67 thus increases. The contact area between each of the protrusions 62, 67 and the adhesive 60 therefore increases. The bonding strength between the first member 351 and the second member 352 can therefore be further increased.

The protrusions 62 and 67 in the bonding layer 53 are made of an inorganic material. The bonding layer 53 can therefore be used in bonding using various materials that require high-temperature sintering. The present disclosure is therefore applicable to a wide range of applications.

Furthermore, the variation shown in FIG. 4 may be applied to the present embodiment, as well as the first and second embodiments.

### Summary of present disclosure

The present disclosure will be summarized below as additional remarks.

### Additional Remark 1

An optical component including: a first member and a second member disposed to face each other, at least one of the first and second members being a light transmissive member; a first uneven portion being a light transmissive portion and configured with multiple first protrusions extending from a first surface of the first member that is a surface facing the second member toward the second member; and an adhesive being a light transmissive adhesive, provided to enter gaps in the first uneven portion, and configured to bond the first member and the second member to each other, wherein in the first uneven portion, an area of a cross-section of each of the first protrusions taken along a plane perpendicular to an extending direction in which the first protrusion extends increases as the first protrusion extends from the first surface toward the second member.

According to the thus configured optical component, an anchor effect is exhibited when a tensile force acts on the adhesive having penetrated into the gaps in the first uneven portion. In this process, a portion of each of the first protrusions that is the portion having an enlarged cross-sectional area bites into the adhesive, so that the bonding between the first protrusion and the adhesive can be strengthened. The bonding strength between the first member and the second member can therefore be increased.

### Additional Remark 2

The optical component according to Additional Remark 1, wherein the first member and the second member are light transmissive members.

According to the configuration described above, since the first and second members of the optical component are light-transmissive members, the optical component can function as a transmissive wavelength converter that outputs light incident via one side thereof via the other side.

### Additional Remark 3

The optical component according to Additional Remark 1 or 2, further including a second uneven portion being a light transmissive portion and configured with multiple second protrusions extending from a second surface of the second member that is a surface facing the first member toward the first member, wherein the adhesive is provided to enter a gap between the first uneven portion and the second uneven portion, and in the second uneven portion, an area of a cross-section of each of the second protrusions taken along a plane perpendicular to an extending direction in which the second protrusion extends increases as the second protrusion extends from the second surface toward the first member.

According to the configuration described above, an anchor effect is exhibited when a tensile force acts on the adhesive having penetrated into the gap between the first uneven portion and the second uneven portion. In this process, a portion of each of the first and second protrusions that is the portion having an enlarged cross-sectional area bites into the adhesive, so that the bonding between the first protrusion and the adhesive and between the second protrusion and the adhesive can be strengthened. The bonding strength between the first member and the second member can therefore be increased.

### Additional Remark 4

The optical component according to Additional Remark 3, wherein the cross-sectional area of each of the first protrusions continuously changes in a direction away from the first surface, and the cross-sectional area of each of the second protrusions continuously changes in a direction away from the second surface.

According to the configuration described above, parameters during manufacturing of the optical component are readily controlled, as compared with a case where the cross-sectional area of each of the first and second protrusions changes stepwise. Management at the time of manufacturing the optical component is therefore facilitated.

### Additional Remark 5

The optical component according to Additional Remark 3, wherein the cross-sectional area of each of the first protrusions changes stepwise in a direction away from the first surface, and the cross-sectional area of each of the second protrusions changes stepwise in a direction away from the second surface.

According to the configuration described above, since the cross-sectional area of each of the first and second protrusions changes stepwise, the surface area of each of the first and second protrusions increases. The contact area between each of the first and second protrusions and the adhesive therefore increases. The bonding strength between the first member and the second member can therefore be further increased.

### Additional Remark 6

A bonding body including: a first member and a second member disposed to face each other; a first uneven portion configured with multiple first protrusions extending from a first surface of the first member that is a surface facing the second member toward the second member; and an adhesive provided to enter gaps in the first uneven portion, and configured to bond the first member and the second member to each other, wherein in the first uneven portion, an area of a cross-section of each of the first protrusions taken along a plane perpendicular to an extending direction in which the first protrusion extends increases as the first protrusion extends from the first surface toward the second member.

According to the configuration described above, an anchor effect is exhibited when a tensile force acts on the adhesive having penetrated into the gaps in the first uneven portion. In this process, a portion of each of the first protrusions that is the portion having an enlarged cross-sectional area bites into the adhesive, so that the bonding between the first protrusion and the adhesive can be strengthened. The bonding strength between the first member and the second member can therefore be increased.

### Additional Remark 7

The bonding body according to Additional Remark 6, further including a second uneven portion configured with multiple second protrusions extending from a second surface of the second member that is a surface facing the first member toward the first member, wherein the adhesive is provided to enter a gap between the first uneven portion and the second uneven portion, and in the second uneven portion, an area of a cross-section of each of the second protrusions taken along a plane perpendicular to an extending direction in which the second protrusion extends increases as the second protrusion extends from the second surface toward the first member.

According to the configuration described above, an anchor effect is exhibited when a tensile force acts on the adhesive having penetrated into the gap between the first uneven portion and the second uneven portion. In this process, a portion of each of the first and second protrusions that is the portion having an enlarged cross-sectional area bites into the adhesive, so that the bonding between the first protrusion and the adhesive and between the second protrusion and the adhesive can be strengthened. The bonding strength between the first member and the second member can therefore be increased.

### Additional Remark 8

The bonding body according to Additional Remark 7, wherein the cross-sectional area of each of the first protrusions continuously changes in a direction away from the first surface, and the cross-sectional area of each of the second protrusions continuously changes in a direction away from the second surface.

According to the configuration described above, parameters during manufacturing of the bonding body are readily controlled, as compared with a case where the cross-sectional area of each of the first and second protrusions changes stepwise. Management at the time of manufacturing the bonding body is therefore facilitated.

### Additional Remark 9

The bonding body according to Additional Remark 7, wherein the cross-sectional area of each of the first protrusions changes stepwise in a direction away from the first surface, and the cross-sectional area of each of the second protrusions changes stepwise in a direction away from the second surface.

According to the configuration described above, since the cross-sectional area of each of the first and second protrusions changes stepwise, the surface area of each of the first and second protrusions increases. The contact area between each of the first and second protrusions and the adhesive therefore increases. The bonding strength between the first member and the second member can therefore be further increased.

What is claimed is:

1. An optical component, comprising:
a first member and a second member disposed to face each other, at least one of the first and second members being a light transmissive member;
a first uneven portion being a light transmissive portion and configured with multiple first protrusions extending, from a first surface of the first member that is a surface facing the second member, toward the second member; and
an adhesive being a light transmissive adhesive, provided to enter gaps in the first uneven portion, and configured to bond the first member and the second member to each other,
wherein in the first uneven portion, an area of a cross-section of each of the first protrusions taken along a plane perpendicular to an extending direction in which the first protrusion extends increases as the first protrusion extends from the first surface toward the second member.

2. The optical component according to claim 1, wherein
the first member and the second member are light transmissive members.

3. The optical component according to claim 1, further comprising
a second uneven portion being a light transmissive portion and configured with multiple second protrusions extending from a second surface of the second member that is a surface facing the first member toward the first member,
wherein the adhesive is provided to enter a gap between the first uneven portion and the second uneven portion, and
in the second uneven portion, an area of a cross-section of each of the second protrusions taken along a plane perpendicular to an extending direction in which the second protrusion extends increases as the second protrusion extends from the second surface toward the first member.

4. The optical component according to claim 3, wherein
a cross-sectional area of each of the first protrusions continuously changes in a direction away from the first surface, and
a cross-sectional area of each of the second protrusions continuously changes in a direction away from the second surface.

5. The optical component according to claim 3, wherein
a cross-sectional area of each of the first protrusions changes stepwise in a direction away from the first surface, and
a cross-sectional area of each of the second protrusions changes stepwise in a direction away from the second surface.

6. A bonding body, comprising:
a first member and a second member disposed to face each other;
a first uneven portion configured with multiple first protrusions extending, from a first surface of the first member that is a surface facing the second member, toward the second member; and
an adhesive provided to enter gaps in the first uneven portion, and configured to bond the first member and the second member to each other,
wherein in the first uneven portion, an area of a cross-section of each of the first protrusions taken along a plane perpendicular to an extending direction in which the first protrusion extends increases as the first protrusion extends from the first surface toward the second member.

7. The bonding body according to claim 6, further including
a second uneven portion configured with multiple second protrusions extending from a second surface of the second member that is a surface facing the first member toward the first member,
wherein the adhesive is provided to enter a gap between the first uneven portion and the second uneven portion, and
in the second uneven portion, an area of a cross-section of each of the second protrusions taken along a plane perpendicular to an extending direction in which the second protrusion extends increases as the second protrusion extends from the second surface toward the first member.

8. The bonding body according to claim 7, wherein
a cross-sectional area of each of the first protrusions continuously changes in a direction away from the first surface, and
a cross-sectional area of each of the second protrusions continuously changes in a direction away from the second surface.

9. The bonding body according to claim 7, wherein
a cross-sectional area of each of the first protrusions changes stepwise in a direction away from the first surface, and
a cross-sectional area of each of the second protrusions changes stepwise in a direction away from the second surface.
